(19) United States
(12) Patent Application Publication
(10) Pub. No.: US 2015/0231850 A1
(43) Pub. Date: Aug. 20, 2015

(54) SANDWICH ELEMENT

(71) Applicant: HERMAN MILLER, INC., ZEELAND, MI (US)

(72) Inventors: Claudia Plikat, Berlin (DE); Johann Burkhard Schmitz, Berlin (DE); Carola Eva Marianne Zwick, Berlin (DE); Roland Rolf Otto Zwick, Berlin (DE)

(73) Assignee: HERMAN MILLER, INC., ZEELAND, MI (US)

(21) Appl. No.: 14/421,293

(22) PCT Filed: Aug. 8, 2013
(86) PCT No.: PCT/US13/54115

§ 371 Date: Feb. 12, 2015

(30) Foreign Application Priority Data
Aug. 14, 2012 (DE) 10 2012 016 071.2
Mar. 25, 2013 (DE) 10 2013 005 033.2

(51) Int. Cl. B32B 3/02; B32B 3/26; B29C 33/00; B32B 5/18; B32B 27/06; B32B 27/32; B32B 7/02; B32B 3/28

(52) U.S. Cl. CPC B32B 3/02; B32B 7/02; B32B 3/266; B32B 3/28; B32B 5/18; B32B 27/065; B32B 27/32; B29C 33/00; B32B 2262/101; B32B 2266/025; B32B 2250/03; B32B 2250/40; B32B 2307/54; B32B 2307/56; B32B 2479/00; B29L 2009/00

(57) ABSTRACT

A sandwich element includes a top layer made of a material having a high tensile strength, a middle layer made of EPP and a bottom layer made of a material having a high tensile strength, wherein the middle layer forms a core having a high compressive strength which runs between the top layer and the bottom layer, which core protrudes beyond the top layer and the bottom layer in such a manner that it forms first and second marginal regions on the top and bottom sides of the sandwich element. A mold, and method of making a sandwich element, are also provided.

### BACKGROUND

DE 195 44 451 A1 discloses three-layered sandwich elements having a top layer made of a material having a high tensile strength, a middle layer made of a polypropylene particle foam and a bottom layer made of a material having a high tensile strength.

### BRIEF SUMMARY

In one embodiment, a sandwich element is provided that is particularly suitable for use in living and office areas, is insensitive to damage in the edge region and presents a reduced risk of injury to people.

The sandwich element includes a first, top layer made of a material having a high tensile strength, an intermediate, middle layer made of EPP and a second, bottom layer made of a material having a high tensile strength and in which the middle layer forms a core having a high compressive strength which runs between the top layer and the bottom layer. This core protrudes beyond the top layer and the bottom layer and forms both a peripheral, or circumferential marginal region on a top side of the sandwich element and a peripheral, or circumferential marginal region on a bottom side of the sandwich element. As a result, a peripheral, circumferential edge region of the sandwich element is formed exclusively from EPP, and therefore has damping and slightly elastic properties. In this construction, the edged top layer and the edged bottom layer lie outside the circumferential edge region of the sandwich element. This design makes it possible to avoid, for example, transportation damage, which can arise owing to ungentle placement of the sandwich element with the edge region on the floor in the case of sandwich elements in particular in the region of the cover plates which form the top layer and the bottom layer. In an installation position in which the sandwich element is used, for example, as a tabletop, too, this structure of the sandwich element makes it possible to avoid damage in the edge region, since the EPP core, which forms the middle layer, is much more insensitive than the top layer. The risk of injury presented by the sandwich element when used as a tabletop, in particular for children, in which the tabletop is arranged at head height, is therefore also considerably lower compared to the risk of injury presented by a conventional, three-layered sandwich element. The core of the invention is therefore a sandwich element which has three layers in a middle region and one layer in an edge region.

Furthermore, provision is made in the case of a sandwich element to form a surface area of the bottom side of the top layer to be smaller than a surface area of the top side of the middle layer, wherein the top layer is arranged on the middle layer in such a manner that the middle layer protrudes in particular circumferentially beyond a margin of the top layer, and to form a surface area of the top side of the bottom layer to be smaller than a surface area of the bottom side of the middle layer, wherein the bottom layer is arranged on the middle layer in such a manner that the middle layer protrudes in particular circumferentially beyond a margin of the bottom layer, and wherein a thickness of the top layer is smaller than a thickness of the middle layer and wherein a thickness of the bottom layer is smaller than the thickness of the middle layer. This creates a sandwich element in which the middle layer forms a marginal protection and reliably protects the top and the bottom layers against stresses which arise in the planes formed by the individual layers.

Provision is also made to form a surface area of a bottom side of the bottom layer to be smaller than a surface area of a top side of the top layer. In its bottom marginal region, the middle layer thereby has a surface which is enlarged compared to its top marginal region, and can thereby show its protective function particularly well for the bottom layer. A bead formed by the marginal regions of the middle layer is bevelled towards the bottom layer. It is thereby possible to reduce the material volume required for the middle layer.

The top layer and the bottom layer may be embedded into the middle layer, or connecting them thereto, in a comparable or different manner. Provision is therefore made for application and/or partial, e.g. half, embedding and/or complete embedding. It is thereby possible, depending on requirements, to form the transition from the top or bottom layer to the middle layer as a flush transition or as a stepped transition. When the top and/or bottom layer is embedded completely, the top or bottom layer is particularly effectively protected by the middle layer in the circumferential marginal region.

Furthermore, the sandwich element may be formed as a single-grade PP sandwich element, wherein the top and the bottom layers are in the form of PP layers, in particular glass fibre reinforced PP layers, and wherein the middle layer is in the form of an EPP layer. The sandwich element can thereby be recycled in a particularly simple and environmentally friendly manner.

The sandwich element may be provided with an opening, the opening being in the form of a depression or of an aperture. If the opening is in the form of a grip, large sandwich elements can also be easily handled by a person. If the opening is in the form of an aperture, sandwich elements can be used for a multiplicity of special applications in which the sandwich element forms a protective frame around a product, for example a display or another unit.

Furthermore, provision is made to equip the sandwich element with at least one reinforcement, wherein the reinforcement is incorporated into the middle layer by foaming, wherein provision is preferably made to connect an add-on part, for example a table leg, to the sandwich element by means of the reinforcement, and wherein for this purpose the reinforcement has a first surface portion connected to the middle layer and a second surface portion which can be connected to the add-on part. It is thereby possible to introduce large forces into the sandwich element even by way of small contact surfaces, and to thus open up further application sectors therefor and to use it in particular as a tabletop, door leaf or cabinet component.

At least one transport space may be formed in the middle layer of the sandwich element, the transport space being accessible through an aperture in the bottom layer. By way of example, a sandwich element formed as a tabletop together with its table legs inserted into the transport spaces can thereby be transported in a manner saving a particularly large amount of space. Furthermore, in everyday use of the sandwich element as a tabletop, the transport space remains concealed by the arrangement of the aperture on the bottom side of the tabletop. Therefore, no disadvantage arises from equipping the sandwich element with transport spaces for the intended use of the sandwich element as a tabletop.

Provision is made to form the marginal region running on the top side of the sandwich element and the marginal region running on the bottom side of the sandwich element each with a width of at least 3 mm, in particular a width of at least 5 mm and preferably a width of at least 10 mm. As a result, the middle layer of the sandwich element is able to compensate even for greater shock loads with elastic deformation and therefore to protect the collision object and the sandwich element as a whole against damage.

Furthermore, provision is made to form all layers as planar plates having a planar top side and a planar bottom side and to give each of these in particular a constant thickness. Plates of this type can be produced easily using a prefabricated top plate and a prefabricated bottom plate, which are connected by way of the middle plate. Alternatively, it is also possible to use a prefabricated middle plate and to machine this at the edges after the plates have been connected. Sandwich elements of this type can be produced in a particularly cost-effective manner, since individual plates which can be produced favourably are used for this purpose.

One embodiment variant provides for forming at least one of the three layers with at least one convex or concave curvature. As a result of such shaping, the sandwich elements can be used for special applications. By way of example, provision is made to provide a tabletop with a depression on a top side and to thereby create a pocket for pens which is integrated into the sandwich element.

The sandwich element is designed in such a way that the marginal regions formed by the middle layer or the bead formed by the middle layer circulate the sandwich element to an extent of at least 50% and in particular circulate it completely. The sandwich element thereby experiences effective protection against undesirable loads.

A mould is provided for producing a sandwich element. In the closed state of the mould, the inner space is delimited by a cover, a floor and a circumferential wall, wherein, during production, the top layer of the sandwich element rests areally on the cover, the bottom layer of the sandwich element rests areally on the floor and the middle layer of the sandwich element lies or is produced between the top layer, the bottom layer and the circumferential wall, and wherein the circumferential wall is offset to the outside both with respect to the cover and with respect to the floor and lies outside an imaginary, rectilinear connection of the cover and of the floor. Using such a mould, the sandwich element according to the invention can be produced without time-consuming and high-cost remachining being required in the region of the bead.

EPP is understood to mean expanded polypropylene where what is involved is a polypropylene-based particle foam.

An EPP layer is understood to mean a layer made of expanded polypropylene.

A PP layer is understood to mean a layer made of polypropylene.

A PP sandwich element is understood to mean a three-layer sandwich element whose base material is polypropylene.

Further details will be described in the drawing on the basis of schematically shown exemplary embodiments.

### BRIEF DESCRIPTION OF THE DRAWINGS

FIG. 1: shows a perspective view of a sandwich element obliquely from above;

FIG. 2: shows a perspective view of the sandwich element shown in FIG. 1 obliquely from below;

FIG. 3: shows a perspective view of the sandwich element shown in FIG. 1 in section in accordance with the line of intersection III-III;

FIG. 4: shows a further perspective view of the sandwich element shown in FIG. 1 in section in accordance with the line of intersection III-III;

FIGS. 5-13: show nine embodiment variants of a sandwich element according to the invention;

FIG. 14: shows an empty mould in a closed position for producing a sandwich element according to the invention;

FIG. 15: shows the mould shown in FIG. 14 with a sandwich element produced therein;

FIG. 16: shows the mould shown in FIG. 14 in an open position;

FIG. 17: shows the sandwich element shown in FIG. 15 and produced in the mould shown in FIG. 14;

FIG. 18: shows an unmachined sandwich element and a form cutter for machining said sandwich element;

FIG. 19: shows the sandwich element shown in FIG. 18 after machining with the form cutter; and

FIGS. 20-22: show three further embodiment variants of sandwich elements according to the invention.

### DETAILED DESCRIPTION OF THE DRAWINGS AND THE PRESENTLY PREFERRED EMBODIMENTS

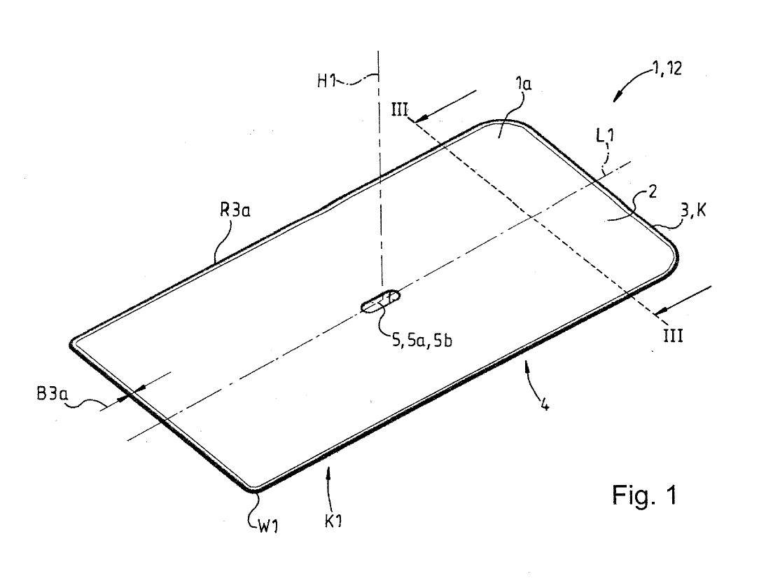

FIG. 1 is a perspective view of a first embodiment variant of a sandwich element 1 according to the invention. The sandwich element 1 comprises a top layer 2, a middle layer 3 and a bottom layer 4, the bottom layer 4 being concealed completely by the middle layer 3 in the view of FIG. 1. The sandwich element 1 has an opening 5, which penetrates the sandwich element 1 completely as an aperture 5a and forms a grip hole 5b, such that the sandwich element 1 can be gripped optionally from the top layer 2 or from the bottom layer 4.

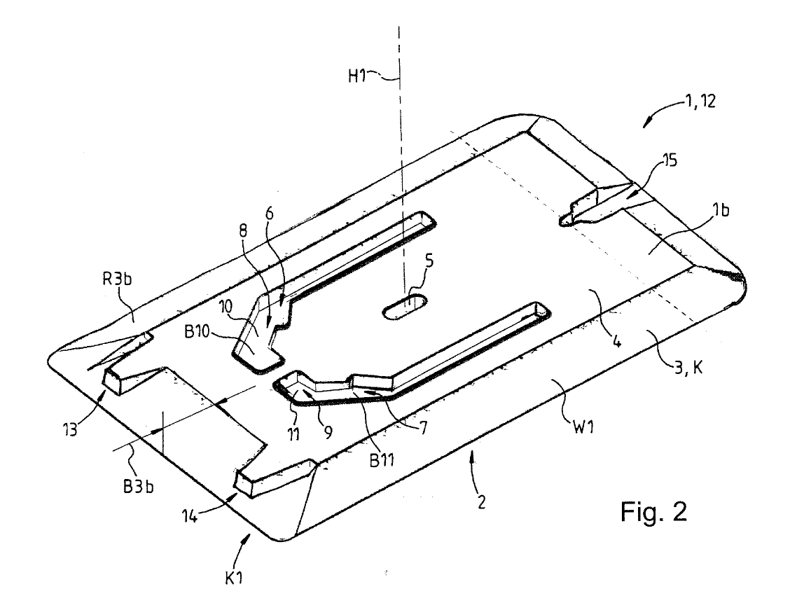

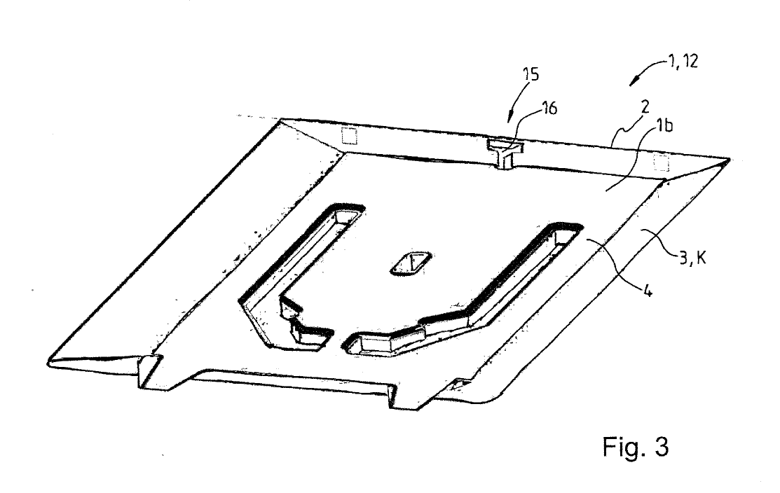

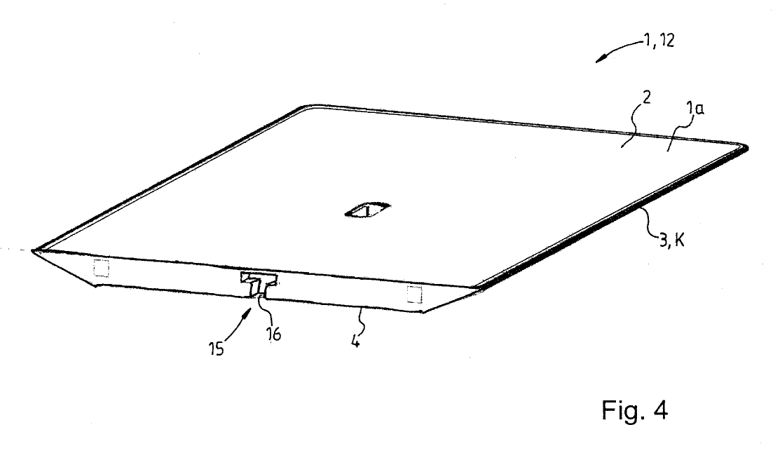

FIG. 2 shows the sandwich element 1 shown in FIG. 1 turned through 180° about a longitudinal axis L1. In this view, the bottom layer 4 is now completely visible. In this view, the top layer 2 is concealed completely by the middle layer 3. In addition to the opening 5, the bottom layer 4 has two apertures 6, 7, which enable access to channel-like depressions 8, 9 formed in the middle layer 3. These channel-like depressions 8, 9 serve as a storage space or transport space 10, 11 for accessories (not shown), with which the sandwich element 1 as a tabletop 12 can be fastened to a supporting structure (not shown), which is formed for example by a partition wall or a shelf or a table. Here, a floor B10 or B11 of the transport spaces 10, 11 is also formed by the middle layer 3. It can be seen from considering FIGS. 1 and 2 together how the middle layer 3 forms a circumferential marginal region R3a protruding laterally beyond the top layer 2 towards a top side 1a of the sandwich element 1 and how the middle layer 3 forms a circumferential marginal region R3b protruding laterally beyond the bottom layer 4 towards a bottom side 1b of the sandwich element 1. Here, the viewing angle is in each case in the direction of a vertical axis H1 running perpendicularly through the sandwich element 1. Owing to the marginal regions R3a and R3b protruding radially outwardly beyond the top layer 2 or the bottom layer 4, a circumferential bead W1 is thus formed on the sandwich element 1, with which bead the middle layer 3 protrudes beyond the top layer 2 and the bottom layer 4. The two marginal regions R3a and R3b each have a width B3a and B3b measured in a perpendicular projection onto the top layer 2. Here, the width B3b is greater than and in particular at least twice as large as the width B3a. The middle layer 3 is in the form of an EPP layer, which has as the bead W1 a closed-pore surface. Three flanges 13, 14 and 15 are formed on the bottom layer 4 and the middle layer 3 towards a circumferential edge region K1 of the sandwich element 1 and serve for connecting the sandwich element 1 to the mentioned accessories and/or the mentioned supporting structures. As is apparent from FIGS. 3 and 4, which show a section through the sandwich element 1 along the line of intersection III-III plotted in FIG. 1, the flange 15 is designed with a T-shaped cross section as a T groove 16.

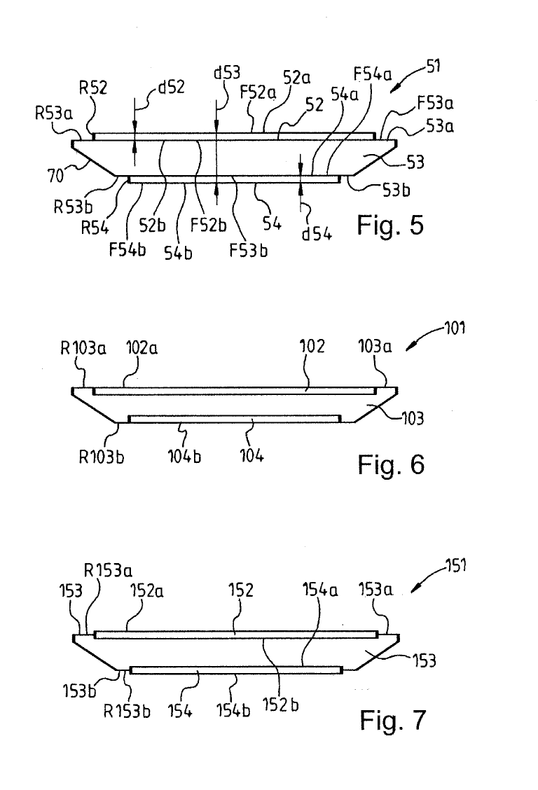

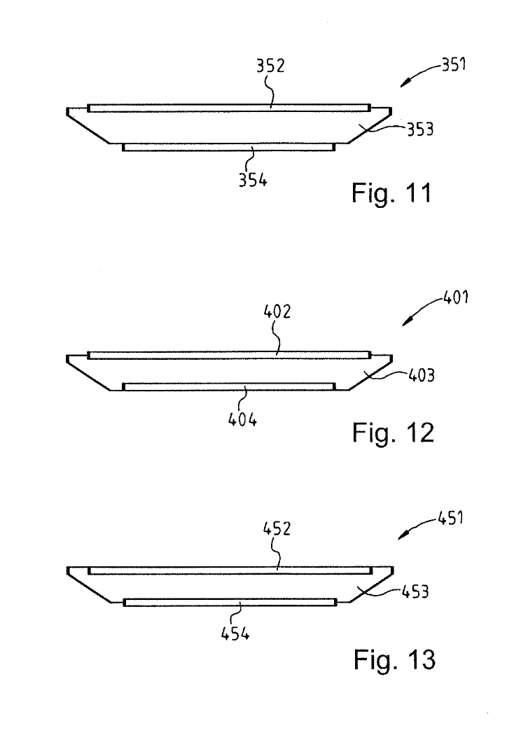

FIGS. 5 to 13 show nine further embodiment variants of sandwich elements. The sandwich elements 51, 101, 151, 201, 251, 301, 351, 401 and 451 are all formed with three layers and each comprise a top layer 52, 102, 152, 202, 252, 302, 352, 402 and 452, a middle layer 53, 103, 153, 203, 253, 303, 353, 403 and 453 and a bottom layer 54, 104, 154, 204, 254, 304, 354, 404 and 454. Here, the top layer and the bottom layer are each placed onto the middle layer or partially embedded into the middle layer or completely embedded into the middle layer.

FIG. 5 shows the sandwich element 51 in a side view. The top layer 52 of the sandwich element 51 has a bottom side 52b, which is oriented onto a top side 53a of the middle layer 53. Here, a surface area F52b of the bottom side 52b of the top layer 52 is smaller than a surface area F53a of the top side 53a of the middle layer 53. The top layer 52 is in this case positioned with respect to the middle layer 53 in such a manner that the middle layer 53 protrudes circumferentially beyond a margin R52 of the top layer 52 with a marginal region R53a. The bottom layer 54 of the sandwich element 51 has a top side 54a oriented onto a bottom side 53b of the middle layer 53. Here, a surface area F54a of the top side 54a of the bottom layer 54 is smaller than a surface area F53b of the bottom side 53b of the middle layer 53. The bottom layer 54 is in this case positioned with respect to the middle layer 53 in such a manner that the middle layer 53 protrudes circumferentially beyond a margin R54 of the bottom layer 54 with a marginal region R53b. Here, a thickness d52 of the top layer 52 is smaller than a thickness d53 of the middle layer 53, and here a thickness d54 of the bottom layer 54 is smaller than the thickness d53 of the middle layer 53. Furthermore, the thicknesses d52 and d54 of the top layer 52 and of the bottom layer 54 are the same. Furthermore, a surface area F54b of a bottom side 54b of the bottom layer 54 is smaller than a surface area F52a of a top side 52a of the top layer 52. In its marginal region R53b, the middle layer 53 has a circumferential bevel 70 toward the bottom layer 54. The top layer 52 is embedded into the middle layer 53 in such a manner that the bottom side 52b of the top layer 52 lies circumferentially on a level with the top side 53a of the circumferential marginal region R53a of the middle layer 53. The bottom layer 54 is embedded into the middle layer 53 in such a manner that the top side 54a of the bottom layer 54 lies circumferentially on a level with the bottom side 53b of the circumferential marginal region R53b of the middle layer 53. The three layers 52, 53 and 54 are each designed as planar plates P52, P53 and P54.

In FIG. 6, the top layer 102 is embedded into the middle layer 103 in such a manner that a marginal region R103a of a top side 103a of the middle layer 103 lies circumferentially on a level with a top side 102a of the top layer 102. The top layer 102 is thus embedded flush into the middle layer 103. The bottom layer 104 is embedded into the middle layer 103 in such a manner that a marginal region R103b of the middle layer 103 lies circumferentially on a level with a bottom side 104b of the bottom layer 104. The bottom layer 104 is thus embedded flush into the middle layer 103.

In FIG. 7, the top layer 152 is embedded into the middle layer 153 in such a manner that a top side 152a of the top layer 152 lies circumferentially above a level of a top side 153a of a circumferential marginal region R153a of the middle layer 153, and that a bottom side 152b of the top layer 152 lies circumferentially below a level of the top side 153a of the circumferential marginal region R153a of the middle layer 153. The bottom layer 154 is embedded into the middle layer 153 in such a manner that a top side 154a of the bottom layer 154 lies circumferentially above a level of a top side 153b of a circumferential marginal region R153b of the middle layer 153, and that a bottom side 154b of the bottom layer 154 lies circumferentially below a level of the bottom side 153b of the circumferential marginal region R153b of the middle layer 153.

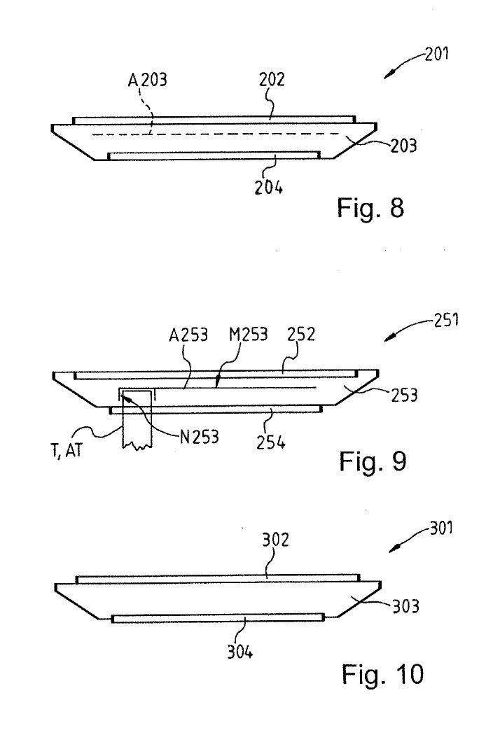

FIGS. 8 to 13 show further embodiment variants regarding the embedding of the top and bottom layers into the middle layer, these embodiment variants arising in each case as a combination of the embedding of the top layer and of the bottom layer as shown in FIGS. 5 to 7.

A dashed line in FIG. 8 denotes a reinforcement A203, which is incorporated into the middle layer 203 by foaming.

FIG. 9 schematically shows a further reinforcement A253, which is likewise incorporated into the middle layer 253 by foaming. An add-on part AT designed as a table leg T is connected to the sandwich element 251 by way of the reinforcement A253. To this end, the reinforcement A253 has a first surface portion M253 connected to the middle layer 253 and a second surface portion N253 which can be connected to the add-on part AT.

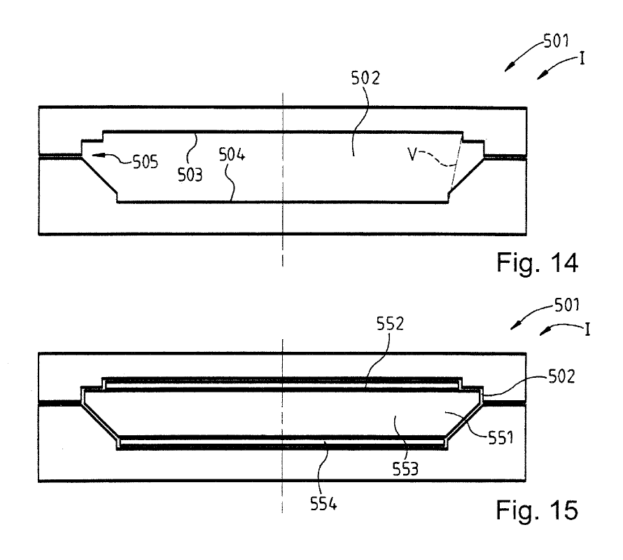

FIG. 14 schematically shows a mould 501 for producing a sandwich element 551 (see FIG. 15). The mould 501 has an inner space 502, in which the sandwich element 551 can be produced. In FIG. 14, the inner space 502 is shown in a closed position I of the mould 501. In said closed position I, the inner space 502 is delimited by a cover 503, a floor 504 and a circumferential wall 505. As is apparent from FIG. 15, which shows the mould 501 in a closed position I with a sandwich element 551 lying in the inner space 502, during production a top layer 552 of the sandwich element 551 rests areally on the cover 503, a bottom layer 554 of the sandwich element 551 rests areally on the floor 504 and a middle layer 553 lies between the top layer 552, the bottom layer 554 and the circumferential wall 505, or is produced therebetween. Here, the circumferential wall 505 is offset circumferentially to the outside both with respect to the cover 503 and with respect to the floor 504 of the inner space 502, and lies at least to an extent of more than 90% outside an imaginary, rectilinear connection V of the cover 503 and of the floor 504, which is indicated by a dashed line in FIG. 14. According to one embodiment variant, it is also provided that the circumferential wall lies completely outside the imaginary connection V.

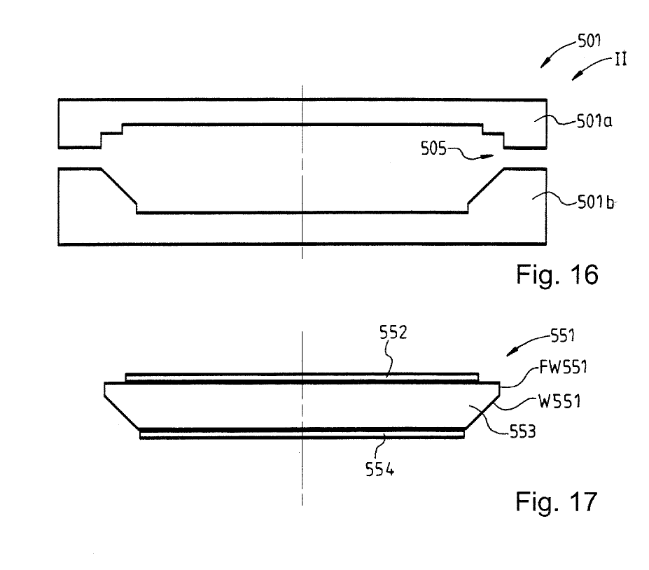

FIG. 16 shows the mould 501 still in an open position II. From this position II, it can be seen that the circumferential wall 505 is formed in part by an upper mould part 501a and in part by a lower mould part 501b.

FIG. 17 shows the sandwich element 551 produced in the mould 501. Said sandwich element has the circumferential bead W551 which is characteristic of the sandwich elements according to the invention and which is formed by the top layer 552 set back circumferentially with respect to the middle layer 553 and the bottom layer 554 set back circumferentially with respect to the middle layer 553. It is also characteristic of the sandwich elements according to the invention that a surface FW551 of the bead W551 is a surface which is produced in an EPP production process. It is thereby possible to produce the surface FW551 of the bead W551 of the sandwich element 551 with closed pores and with an appealing visual effect.

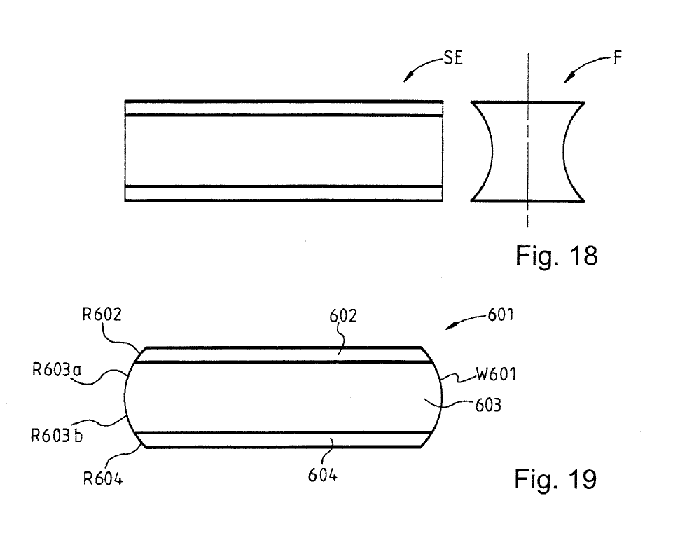

Alternatively, it is also provided—as shown in FIG. 18—to produce a sandwich element 601 according to the invention as shown in FIG. 19 from a three-layer sandwich element SE which has a cuboidal basic shape with the aid of a form cutter F, in which sandwich element a middle layer 603 of the sandwich element 601 protrudes with a bead W601 with a top marginal region R603a beyond a margin R602 of a top layer 602 and protrudes with the bead W601 with a bottom marginal region R603b beyond a margin R604 of a bottom layer 604. With such a production and when the middle layer 603 is formed as an EPP plate, the sandwich element 601 obtains an open-pore surface in the region of its circumferential bead W601.

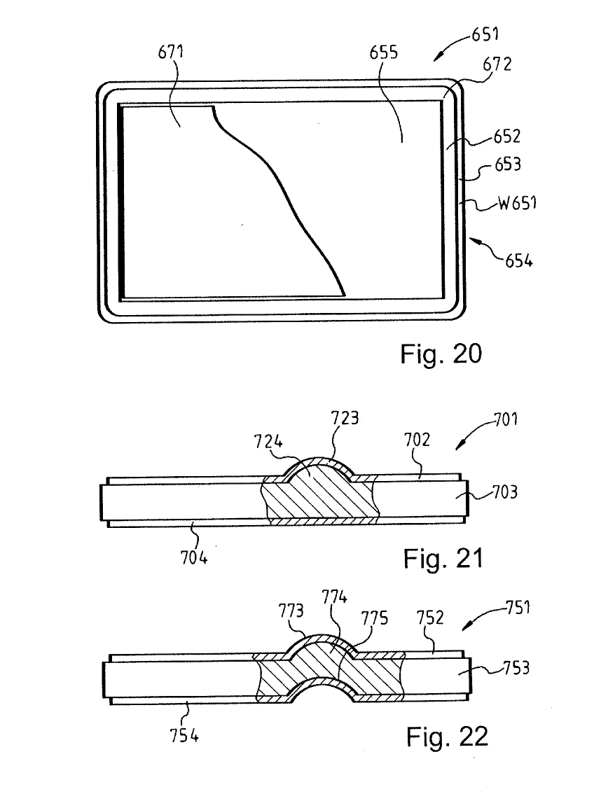

FIG. 20 shows a further sandwich element 651. This has an opening 655, which pierces through a top layer 652, a middle layer 653 and a bottom layer 654. A display 671 shown in section, for which the sandwich element 651 forms a frame 672, is arranged in said opening 655. The display 671 is protected optimally by a bead W651 formed from the middle layer 653.

FIG. 21 shows a further sandwich element 701 in a partially sectional side view. In the case of this sandwich element 701, a top layer 702 and a middle layer 703 each have a convex curvature 723, 724. A bottom layer 704 is formed as a planar plate.

FIG. 22 finally shows a sandwich element 751 in a partially sectional side view. In the case of this sandwich element 751, a top layer 752, a middle layer 753 and a bottom layer 754 each have a convex curvature 773, 774 and 775, these curvatures 773, 774 and 775 being arranged one above another.

The invention is not restricted to exemplary embodiments illustrated or described. On the contrary, it comprises developments of the invention within the scope of the patent claims.

### LIST OF REFERENCE SIGNS

1 Sandwich element
1a Top side of 1
1b Bottom side of 1
2 Top layer of 1
3 Middle layer of 1
4 Bottom layer of 1
5 Grip hole
6, 7 Aperture in 4
8, 9 Channel-like depression in 3
10, 11 Transport space
12 Tabletop
13, 14, 15 Flange on 1
16 T groove
B3a, B3b Width of R3a or R3b
B10, B11 Floor of 10, 11
H1 Vertical axis of 1
K Core
K1 Edge region
R3a Marginal region of 3 or 1
R3b Marginal region of 3 or 1
W1 Bead of 1
51 Sandwich element
52 Top layer
52a Top side
52b Bottom side
53 Middle layer
53a Top side
53b Bottom side
54 Bottom layer
54a Top side
54b Bottom side
d52 Thickness
d53 Thickness
d54 Thickness
F52a Surface area
F52b Surface area
F53a Surface area
F53b Surface area
F54b Surface area
P52, P53, P54 Planar plate
R52 Margin
R53a Marginal region
R53b Marginal region
R54 Margin
70 Circumferential bevel
101 Sandwich element
102 Top layer
102a Top side
103 Middle layer
103a Top side of 103
104 Bottom layer
104b Bottom side
R103a Marginal region
R103b Marginal region
151 Sandwich element
152 Top layer
152a Top side
152b Bottom side
153 Middle layer
153a Top side
154 Bottom layer
154a Top side
154b Bottom side
R153a Marginal region
R153b Marginal region
201 Sandwich element
202 Top layer
203 Middle layer
204 Bottom layer
A203 Reinforcement
251 Sandwich element
252 Top layer
253 Middle layer
254 Bottom layer
A253 Reinforcement
AT Add-on part
M253 First surface portion of A253
N253 Second surface portion of A253
T Table leg
301 Sandwich element
302 Top layer
303 Middle layer
304 Bottom layer
351 Sandwich element
352 Top layer
353 Middle layer
354 Bottom layer
401 Sandwich element
402 Top layer
403 Middle layer
404 Bottom layer
451 Sandwich element
452 Top layer
453 Middle layer
454 Bottom layer
501 Mould
501a Upper mould part of 501
501b Lower mould part of 501
502 Inner space of 501
503 Cover of 502
504 Floor of 502
505 Circumferential wall of 502
I Closed position of 501
II Open position of 501
V Connection between 503 and 504
551 Sandwich element
552 Top layer of 551
553 Middle layer of 551
554 Bottom layer of 551
W551 Circumferential bead of 551
FF551 Surface of the bead W551
601 Sandwich element
602 Top layer
603 Middle layer
604 Bottom layer
F Form cutter
R602 Margin
R603a Marginal region
R603b Bottom marginal region
R604 Margin
W601 Bead
651 Sandwich element
652 Top layer
653 Middle layer
654 Bottom layer
655 Opening
671 Display
672 Frame
W651 Bead
701 Sandwich element
702 Top layer
703 Middle layer
704 Bottom layer
723, 724 Convex curvature
751 Sandwich element
752 Top layer
753 Middle layer
754 Bottom layer
773-775 Convex curvature

1-15. (canceled)

16. A sandwich element comprising:
a first layer made of a material having a high tensile strength;
an intermediate layer made of expanded polypropylene; and
a second layer made of a material having a high tensile strength, wherein the intermediate layer forms a core having a high compressive strength, the core being disposed between the first and second layers, wherein the core protrudes beyond the first and second layers and forms first and second marginal regions relative to the first and second layers respectively.

17. The sandwich element according to claim 16 wherein the first layer has a first side facing a first side of the intermediate layer, wherein the first side of the first layer has a surface area that is smaller than a surface area of the first side of the intermediate layer, wherein the first layer is arranged on the intermediate layer in such a manner that the first marginal region extends around a periphery of the first layer.

18. The sandwich element according to claim 17 wherein the second layer has a first side facing a second side of the intermediate layer, wherein the first side of the second layer has a surface area that is smaller than a surface area of the second side of the intermediate layer, wherein the second layer is arranged on the intermediate layer in such a manner that the second marginal region extends around a periphery of the second layer.

19. The sandwich element according to claim 18 wherein a thickness of the first layer is less than a thickness of the intermediate layer.

20. The sandwich element according to claim 19 wherein a thickness of the second layer is less than the thickness of the intermediate middle layer.

21. The sandwich element according to claim 20 wherein a surface area of a second side of the second layer facing away from the intermediate layer is smaller than a surface area of a second side of the first layer facing away from the intermediate layer.

22. The sandwich element according to claim 16 wherein an edge of the intermediate region extending between the first and second marginal regions is bevelled.

23. The sandwich element according to claim 16 wherein the first layer is embedded into the intermediate layer, wherein an outer surface of the first layer lies flush with an outer surface of the first marginal region.

24. The sandwich element according to claim 16 wherein the first layer is embedded into the intermediate layer, wherein outer and inner surfaces of the first layer are offset from a surface of the first marginal region.

25. The sandwich element according to claim 16 wherein the first layer is embedded into the intermediate layer, wherein an inner surface of the first layer lies flush with an outer surface of the first marginal region.

26. The sandwich element according to claim 16 wherein the second layer is embedded into the intermediate layer, wherein an outer surface of the second layer lies flush with an outer surface of the second marginal region.

27. The sandwich element according to claim 16 wherein the second layer is embedded into the intermediate layer, wherein outer and inner surfaces of the second layer are offset from a surface of the second marginal region.

25. The sandwich element according to claim 16 wherein the second layer is embedded into the intermediate layer, wherein an inner surface of the second layer lies flush with an outer surface of the second marginal region.

26. The sandwich element according to claim 16 wherein the first and second layers each comprise a glass fibre reinforced polypropylene material.

27. The sandwich element according to claim 16 wherein the first, intermediate and second layers have an aligned through-opening extending through each of the first, intermediate and second layers.

28. The sandwich element according to claim 16 wherein the intermediate layer comprises at least one reinforcement embedded therein.

29. The sandwich element according to claim 16 further comprising a leg coupled to the at least one reinforcement.

30. The sandwich element according to claim 16, wherein the intermediate layer comprises at least one transport space being accessible through an aperture formed in the second layer.

31. The sandwich element according to claim 16, wherein the first and second marginal regions each have a width of at least 3 mm.

32. The sandwich element according to claim 16 claims, wherein the first, intermediate and second layers are each formed as planar plates having first and second sides, and wherein each of the first, intermediate and second layers have a constant thickness.

33. The sandwich element according to claim 16 wherein at least one of the first, intermediate and second layers has at least one convex or concave curvature.

34. The sandwich element according to claim 16 wherein the first and second marginal regions extend around at least 50% of a periphery of each of the first and second layers.

35. A mold for producing a sandwich element comprising:
a floor, a cover and a peripheral wall defining an inner space, wherein the floor comprises a first recess shaped to receive a first layer, and the cover comprises a second recess shaped to receive a second layer, wherein the peripheral wall is outwardly offset from and surrounds the first and second recesses.
